(19) United States
(12) Patent Application Publication
(10) Pub. No.: US 2026/0042311 A1
(43) Pub. Date: Feb. 12, 2026

(54) ARTICLE WITH HIGH REFLECTANCE INK LAYER AND OPAQUE INK LAYER

(71) Applicant: CORNING INCORPORATED, CORNING, NY (US)

(72) Inventors: Bibi Ji, Hefei (CN); Ling Qiu, Hefei city (CN); Genrong Shao, Hefei City (CN); Fang Sun, Hefei city (CN); Yawei Sun, Elmira, NY (US)

(21) Appl. No.: 19/287,993

(22) Filed: Aug. 1, 2025

(30) Foreign Application Priority Data
Aug. 9, 2024 (CN) 202411099574.9

(51) Int. Cl. B41M 5/52; B41M 5/00; B41M 7/00; C08J 3/28; C08J 5/18; C08J 7/04; C09D 11/101

(52) U.S. Cl. CPC B41M 5/52; B41M 5/0047; B41M 7/00; C08J 3/28; C08J 5/18; C08J 7/042; C09D 11/101

(57) ABSTRACT

An article including: (a) a substrate (i) including a first primary surface and a second primary surface facing generally away from the first primary surface and (ii) exhibiting a substrate index of refraction; (b) a first layer of a high reflectance ink (i) layered over the second primary surface of the substrate, and (ii) exhibiting an ink index of refraction that is greater than the substrate index of refraction; and (c) a second layer of a substantially opaque ink, the second layer layered over the first layer, with the first layer sandwiched between the second layer and the substrate. The first layer is substantially free of a metallic component. For electromagnetic radiation throughout an entirety of the visible spectrum initially transmitted through the first primary surface of the substrate and incident on the first layer, the article exhibits an average reflectance that is greater than or equal to 4%.

### CROSS-REFERENCE TO RELATED APPLICATIONS

This application claims the benefit of priority of Chinese Patent Application Number 202411099574.9, filed on Aug. 9, 2024, the content of which is relied upon and incorporated herein by reference in its entirety.

### TECHNICAL FIELD

The present disclosure pertains to articles with a transparent substrate and high reflectance ink.

### BACKGROUND

Substrates exhibiting a metallic visual appearance provide aesthetic benefits that are useful in a variety of applications. Appliances, architectural elements (e.g., walls, windows, mirrors, etc.), and vehicles (e.g., automobiles, aircraft, seacraft, rail cars) are all example applications for such substrates.

To provide such a metallic appearance, certain existing approaches utilize a metal substrate or a metal-containing ink layer. However, such approaches are suboptimally expensive. That is so because the cost of the metal as a raw material can be suboptimal and processes to apply the metal to the non-metallic surface (e.g., vapor deposition) can be suboptimally expensive and time consuming. Further, using metals to impart a metallic visual appearance limits the range of colors that can be made to appear metallic.

### SUMMARY

The present disclosure addresses those problems with an article that includes a substrate with a primary surface, a first layer of high reflectance ink over the primary surface of the substrate, and a second layer of a substantially opaque ink over the first layer. The first layer of high reflectance ink enhances the reflectivity of visible light initially incident through the substrate back through the substrate compared to if only the second layer of the substantially opaque ink were present on the substrate. The enhanced reflectivity makes the second layer of the substantially opaque ink appear more colorful through the substrate compared to if only the second layer of the substantially opaque ink were present on the substrate. In many instances, the enhanced reflectivity makes the article appear metallic.

According to a first aspect of the present disclosure, an article comprises: (a) a substrate (i) comprising a first primary surface and a second primary surface facing generally away from the first primary surface and (ii) exhibiting a substrate index of refraction; (b) a first layer of a high reflectance ink (i) layered over the second primary surface of the substrate, with the first layer directly contacting the second primary surface of the substrate, and (ii) exhibiting an ink index of refraction that is greater than the substrate index of refraction; and (c) a second layer of a substantially opaque ink, the second layer layered over the first layer, with the first layer sandwiched between the second layer and the substrate; wherein (i) the first layer is substantially free of a metallic component, and (ii) for electromagnetic radiation throughout an entirety of the visible spectrum initially transmitted through the first primary surface of the substrate and incident on the first layer, the article exhibits an average reflectance that is greater than or equal to 4%.

According to a second aspect of the present disclosure, the article of the first aspect is presented, wherein (i) the substrate further comprises a thickness between the first primary surface and the second primary surface, and (ii) the thickness of the substrate is within a range of from 0.1 mm to 5.0 mm.

According to a third aspect of the present disclosure, the article of any one of the first through second aspects is presented, wherein the substrate alone exhibits a transmittance of electromagnetic radiation throughout an entirety of the visible spectrum that is greater than or equal to 80%.

According to a fourth aspect of the present disclosure, the article of any one of the first through third aspects is presented, wherein (i) the first layer comprises a thickness orthogonal to the second primary surface of the substrate, and (ii) the thickness of the first layer is within a range of from 2.0 μm to 10.0 μm.

According to a fifth aspect of the present disclosure, the article of any one of the first through fourth aspects is presented, wherein the high reflectance ink of the first layer comprises a resin.

According to a sixth aspect of the present disclosure, the article of any one of the first through fifth aspects is presented, wherein the high reflectance ink comprises a non-metallic colorant.

According to a seventh aspect of the present disclosure, the article of any one of the first through sixth aspects is presented, wherein the first layer directly contacts the second primary surface of the substrate.

According to an eighth aspect of the present disclosure, the article of any one of the first through seventh aspects is presented, wherein the first layer alone exhibits a transmittance of electromagnetic radiation throughout an entirety of the visible spectrum that is greater than or equal to 50%.

According to a ninth aspect of the present disclosure, the article of any one of the first through eighth aspects is presented, wherein the first layer exhibits a reflectance of greater than or equal to 1% throughout an entirety of the visible spectrum for electromagnetic radiation that is initially transmitted through the substrate and incident on the first layer.

According to a tenth aspect of the present disclosure, the article of any one of the first through ninth aspects is presented, wherein the second layer is disposed directly on the first layer without any other interlayer therebetween.

According to an eleventh aspect of the present disclosure, the article of any one of the first through tenth aspects is presented, wherein the article exhibits an average reflectance throughout an entirety of the visible spectrum of electromagnetic radiation initially transmitted through the substrate that is greater than an average reflectance that a comparative article with only the substrate and the second layer disposed directly on the substrate exhibits.

According to a twelfth aspect of the present disclosure, the article of the eleventh aspect is presented, wherein the average reflectance that the article exhibits is at least 0.1% greater than the average reflectance that the comparative article exhibits.

According to a thirteenth aspect of the present disclosure, the article of the twelfth aspect is presented, wherein the article exhibits an L* value, with the specular component included (SCI) under the CIE colorimetric system, that is greater than the L* value that a comparative article with only the substrate and the second layer disposed directly on the substrate exhibits.

According to a fourteenth aspect of the present disclosure, the article of the thirteenth aspect is presented, wherein the article compared to the comparative article, exhibits a ΔE, with the specular component included (SCI) under the CIE colorimetric system, that is less than 1.0.

According to a fifteenth aspect of the present disclosure, an article comprises: (a) a substrate (i) comprising a first primary surface and a second primary surface facing generally away from the first primary surface and (ii) exhibiting a substrate index of refraction; (b) a first layer of a high reflectance ink (i) layered over the second primary surface of the substrate and (ii) exhibiting an ink index of refraction that is greater than the substrate index of refraction; and (c) a second layer of a substantially opaque ink, the second layer layered over the first layer, with the first layer sandwiched between the second layer and the substrate; wherein (i) for electromagnetic radiation throughout an entirety of the visible spectrum initially transmitted through the first primary surface of the substrate and incident on the first layer, the article exhibits an average reflectance that is greater than or equal to 4%, and (ii) the article exhibits an L* value, with the specular component included (SCI) under the CIE colorimetric system, that is greater than or equal to 24 when measured from a viewpoint toward the first primary surface.

According to a sixteenth aspect of the present disclosure, the article of the fifteenth aspect is presented, wherein the first layer is substantially free of a metallic component.

According to a seventeenth aspect of the present disclosure, the article of any one of the fifteenth through sixteenth aspects is presented, wherein the article exhibits a CIE colorimetry system a* value, with the specular component included, that is within a range of from −2.0 to 2.0, and a b* value, with the specular component included, that is likewise within a range of from −2.0 to 2.0.

According to an eighteenth aspect of the present disclosure, the article of any one of the fifteenth through sixteenth aspects is presented, wherein the article exhibits a CIE colorimetry system a* value, with the specular component included, that is within a range of from 3.0 to 14.0, and a b* value, with the specular component included, that is likewise within a range of from 1.0 to 7.0.

According to a nineteenth aspect of the present disclosure, the article of any one of the fifteenth through sixteenth aspects is presented, wherein the article exhibits a CIE colorimetry system a* value, with the specular component included, that is within a range of from 1.0 to 6.0, and a b* value, with the specular component included, that is likewise within a range of from 22.0 to 32.0.

According to a twentieth aspect of the present disclosure, a method of making the article of any one of the first through eighteenth aspects comprises: (1) a first printing step comprising printing the first layer of the high reflectance ink onto the second primary surface of the substrate; (2) a first curing step comprising curing the first layer, the first curing step performed after the first printing step; (3) a second printing step comprising printing the second layer onto the first layer, the second printing step performed after the first curing step; and (4) a second curing step comprising curing the second layer, the second curing step performed after the second printing step.

According to a twenty-first aspect of the present disclosure, the method of the twentieth aspect is presented, wherein the printing of the first printing step comprises inkjet printing, screen printing, pad printing, or spin printing the first layer of the high reflectance ink onto the second primary surface of the substrate.

According to a twenty-second aspect of the present disclosure, the method of any one of the twentieth through twenty-first aspects is presented, wherein the first curing step comprises curing the first layer with one or more of ultraviolet light, thermal treatment, and infrared light.

According to a twenty-third aspect of the present disclosure, the method of any one of the twentieth through twenty-second aspects is presented, wherein after the first curing step but before the second printing step, the article exhibits a CIE colorimetry system L* value, with the specular component included, that is within a range of from 35 to 45.

According to a twenty-fourth aspect of the present disclosure, the method of any one of the twentieth through twenty-third aspects is presented, wherein the method is free of an etching step that removes a portion of the first layer or the second layer.

### BRIEF DESCRIPTION OF THE DRAWINGS

In the Drawings:

FIG. 1 is a perspective view of an article of the present disclosure, illustrating a substrate, a first layer of high reflective ink disposed on a primary surface of the substrate, and a second layer of a substantially opaque ink disposed on the first layer of the high reflective ink;

FIG. 2 is a cross-sectional view of the article of FIG. 1 taken orthogonally to the primary surface of the substrate, illustrating, in a phantom view, a functional layer disposed over another primary surface of the substrate;

FIG. 3 is a schematic diagram of a method of making the article of FIG. 1, illustrating a first printing step to apply the first layer of the high reflective ink, a first curing step to cure (at least partially) the first layer of the high reflective ink, a second printing step to apply the second layer of the substantially opaque ink, and a second curing step to cure (at least partially) the second layer of the substantially opaque ink;

FIG. 4, pertaining to Example 1, is a graph plotting transmission percentage as a function of wavelength for a workpiece including the substrate and the first layer of the high reflectance ink, illustrating a high level of transmittance through an entirety of the visible spectrum;

FIG. 5, again pertaining to Example 1, is a graph plotting reflectance as a function of wavelength that the workpiece exhibits for visible light initially incident through the first primary surface of the substrate toward the first layer of the high reflectance ink, illustrating that the high reflectance ink causes the workpiece to exhibit a reflectance within a range of about 1% to about 2% throughout the entirety of the visible spectrum;

FIG. 6, pertaining to Example 2, shows an experimental set up where “location 0” is the substrate alone, “location 1” is a workpiece with the first layer of the high reflectance ink on the primary surface of the substrate, “location 2” is an embodiment of the article of the present disclosure with the second layer of the substantially opaque ink disposed on the first layer of the high reflectance ink, and “location 3” is another workpiece with the second layer of the substantially opaque ink on the primary surface of the substrate and without the first layer of the high reflectance ink;

FIG. 7, again pertaining Example 2, is a graph plotting reflectance as a function of wavelength that the article of “location 2” exhibits and the workpiece of “location 3” exhibits for visible light initially incident through the first primary surface of the substrate, illustrating that the inclusion of the first layer of the high reflectance ink causes the article of “location 2” to exhibit enhanced reflectivity compared to the workpiece of “location 3” through the entirety of the visible spectrum;

FIG. 8, pertaining to Example 3, which uses the same first layer as Example 2 but uses a different ink for the second layer of the substantially opaque ink, is a graph similar to the graph of FIG. 7 and illustrating the same enhanced reflectivity for the article of “location 2”;

FIG. 9, pertaining to Example 4, which uses the same first layer as Examples 2 and 3 but uses a different ink for the second layer of the substantially opaque ink, is a graph similar to the graph of FIG. 7 and illustrating the same enhanced reflectivity for the article of “location 2”;

FIG. 10, pertaining to Example 5, which uses the same first layer as Examples 2-4 but uses a different ink for the second layer of the substantially opaque ink, is a graph similar to the graph of FIG. 7 and illustrating the same enhanced reflectivity for the article of “location 2”;

FIG. 11, pertaining to Example 5, shows the same experimental setup as FIG. 6 and illustrates the article of “location 2” exhibiting the gold color of the second layer of the substantially opaque ink more vividly (and metallic in nature) than the workpiece of “location 3” due to the inclusion of the first layer of the high reflectance ink;

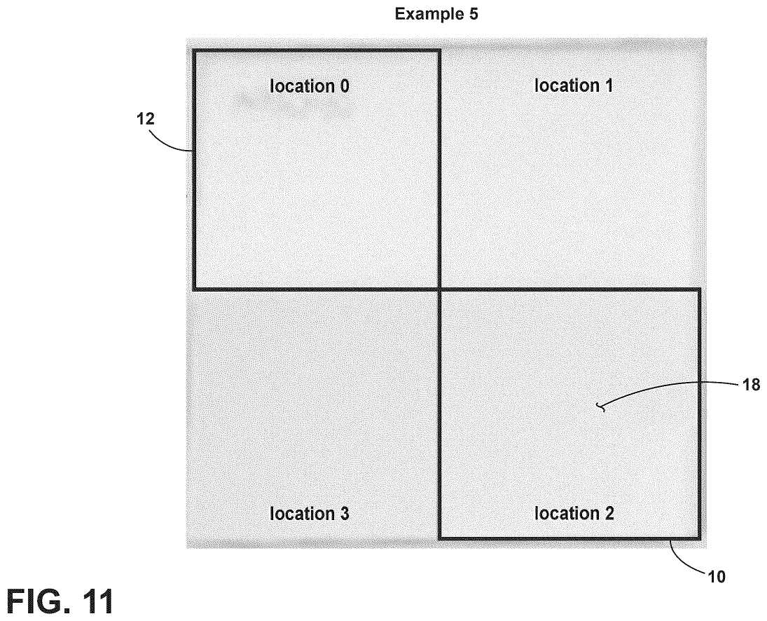

FIG. 12, pertaining to Example 6, is a graph plotting reflectance as a function of wavelength for: (i) a workpiece including a substrate and a high reflectance ink that is different from the high reflectance ink of the workpiece of FIG. 5; and (ii) a comparative workpiece including the substrate and a non-high reflectance ink for visible light initially incident through the first primary surface of the substrate toward the first layer of the high reflectance ink, illustrating that the high reflectance ink enhances reflectance that the workpiece exhibits throughout some ranges of the visible spectrum but not others;

FIG. 13, pertaining to Example 7, which uses the same first layer as Example 6 but uses a different ink for the second layer of the substantially opaque ink, is a graph similar to the graph of FIG. 7 and illustrating the same enhanced reflectivity for the article of “location 2”;

FIG. 14, pertaining to Example 8, which uses the same first layer as Example 7 but uses a different ink for the second layer of the substantially opaque ink, is a graph similar to the graph of FIG. 12 and illustrating the same enhanced reflectivity for the article of “location 2” at least for portions of the visible spectrum but not others;

FIG. 15, pertaining to Example 9, which uses the same first layer as Examples 7 and 8 but uses a different ink for the second layer of the substantially opaque ink, is a graph similar to the graph of FIG. 23 and illustrating the same enhanced reflectivity for the article of “location 2” at least for portions of the visible spectrum but not others;

FIG. 16, pertaining to Example 10, which uses the same first layer as Examples 7-9 but uses a different ink for the second layer of the substantially opaque ink, is a graph similar to the graph of FIG. 12 and illustrating the same enhanced reflectivity for the article of “location 2” at least for portions of the visible spectrum but not others; and

FIG. 17, pertaining to Example 11, which uses the same first layer as Examples 7-10 but uses a different ink for the second layer of the substantially opaque ink, is a graph similar to the graph of FIG. 12 and illustrating the same enhanced reflectivity for the article of “location 2” throughout the entirety of the visible spectrum.

### DETAILED DESCRIPTION

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description, explain principles and operation of the various embodiments.

Reference will now be made in detail to the present preferred embodiments, examples of which are illustrated in the accompanying drawings. Whenever possible, the same reference numerals will be used throughout the drawings to refer to the same or like parts.

It will be apparent to those skilled in the art that various modifications and variations can be made without departing from the spirit or scope of the claims.

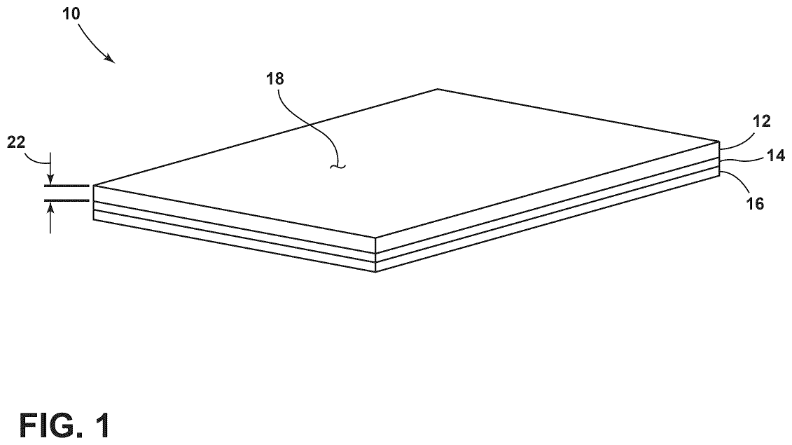

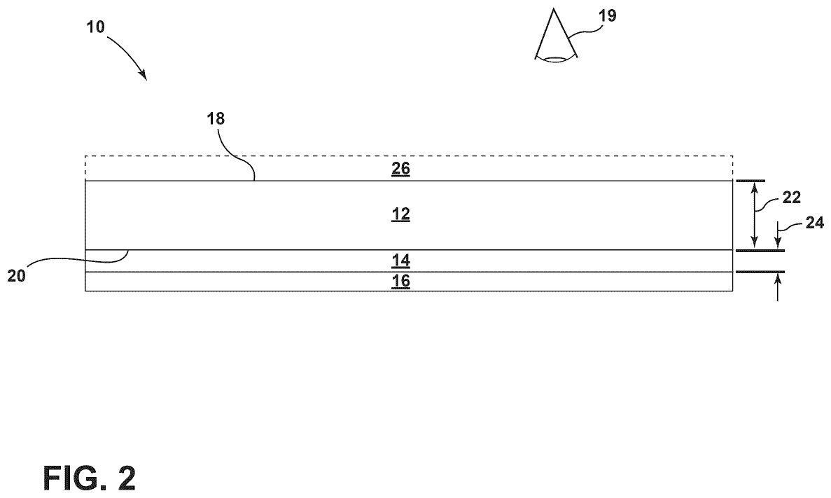

Referring to FIGS. 1 and 2, an article 10 is herein disclosed. The article 10 includes a substrate 12, a first layer 14 of a high reflectance ink, and a second layer 16 of a substantially opaque ink. The substrate 12 includes a first primary surface 18 and a second primary surface 20. The first primary surface 18 and the second primary surface 20 generally face away from each other. In embodiments, the first primary surface 18 and the second primary surface 20 are each planar and parallel but need not be. Other geometries are envisioned. In embodiments, the first primary surface 18 is positioned to face an eye 19 of an intended viewer.

The substrate 12 exhibits a substrate index of refraction. In embodiments, the substrate index of refraction is within a range of from 1.3 to 1.8. For example, the substrate index of refraction can be 1.3, 1.4, 1.5, 1.6, 1.7, 1.8, or within any range bound by any two of those values (e.g., from 1.5 to 1.7, from 1.4 to 1.6, and so on). For purposes of this disclosure, any index of refraction enumerated herein is for a wavelength of 633 nm and at standard temperature and pressure.

The substrate 12 has a thickness 22. The thickness 22 is the shortest straight-line distance between the first primary surface 18 and the second primary surface 20. In embodiments, the thickness 22 of the substrate 12 is within a range of from 0.1 mm to 5.0 mm. For example, the thickness 22 can be 0.1 mm, 0.5 mm, 1.0 mm, 1.5 mm, 2.0 mm, 2.5 mm, 3.0 mm, 3.5 mm, 4.0 mm, 5.0 mm, or within any range bound by any two of those values (e.g., from 0.5 mm to 1.5 mm, from 2.0 mm to 3.5 mm, and so on). The thickness 22 can be measured with a micrometer.

The substrate 12 alone (e.g., not combined as part of the article 10) exhibits a transmittance of electromagnetic radiation throughout an entirety of the visible spectrum (e.g., from 400 nm to 700 nm) that is greater than or equal to 80%. For example, the transmittance can be 80%, 81%, 82%, 83%, 84%, 85%, 86%, 87%, 88%, 89%, 90%, 91%, 92%, 93%, 94%, 95%, 96%, or within any range bound by any two of those values (e.g., from 82% to 94%, from 85% to 93%, and so on). For purposes of this disclosure, “transmittance” is the percentage of incident optical power within a given wavelength range transmitted through the material at issue. Transmittance is measured in accordance with ASTM E903-12. In addition, transmittance is measured using a specific linewidth. In embodiments, the spectral resolution of the characterization of the transmittance is less than 5 nm or 0.02 eV. Unless otherwise noted, transmittance values provided herein are at a normal incidence angle.

The substrate 12 has a composition. The composition is not particularly important to the disclosure. For example, the composition of the substrate 12 can be a polymer, such as polymethyl methacrylate (PMMA) or polycarbonate.

As another example, the composition of the substrate 12 can be a glass. Suitable glasses include soda lime glass, aluminosilicate glass, borosilicate glass, boroaluminosilicate glass, alkali-containing aluminosilicate glass, alkali-containing borosilicate glass, and alkali-containing boroaluminosilicate glass.

As yet another example, the composition of the substrate 12 can be a glass-ceramic material produced through controlled crystallization of glass. In such embodiments, glass-ceramics have about 30% to about 90% crystallinity. Non-limiting examples of glass ceramic systems that may be used include Li₂O×Al₂O₃×nSiO₂ (e.g., LAS system), MgO×Al₂O₃×nSiO₂ (e.g., MAS system), and ZnO×Al₂O₃×nSiO₂ (e.g., ZAS system).

Unless otherwise specified, the glass compositions disclosed herein are described in mole percentage (mol %) as analyzed on an oxide basis.

In embodiments, the glass composition includes SiO₂ in an amount within a range of from 66 mol % to 80 mol %. For example, the amount of SiO₂ can be 66 mol %, 67 mol %, 68 mol %, 69 mol %, 70 mol %, 71 mol %, 72 mol %, 73 mol %, 74 mol %, 75 mol %, 76 mol %, 77 mol %, 78 mol %, 79 mol %, 80 mol %, or within any range bound by any two of those values (e.g., from 68 mol % to 79 mol %, from 72 mol % to 75 mol %, and so on).

In embodiments, the glass composition includes Al₂O₃ in an amount within a range of from 1 mol % to 20 mol %. For example, the amount of Al₂O₃ can be 1 mol %, 2 mol %, 3 mol %, 4 mol %, 5 mol %, 6 mol %, 7 mol %, 8 mol %, 9 mol %, 10 mol %, 11 mol %, 12 mol %, 13 mol %, 14 mol %, 15 mol %, 16 mol %, 17 mol %, 18 mol %, 19 mol %, 20 mol %, or within any range bound by any two of those values (e.g., from 9 mol % to 14 mol %, from 2 mol % to 18 mol %, and so on).

In embodiments, the glass composition includes B₂O₃ in an amount within a range of from 1 mol % to 20 mol %. For example, the amount of B₂O₃ can be 1 mol %, 2 mol %, 3 mol %, 4 mol %, 5 mol %, 6 mol %, 7 mol %, 8 mol %, 9 mol %, 10 mol %, 11 mol %, 12 mol %, 13 mol %, 14 mol %, 15 mol %, 16 mol %, 17 mol %, 18 mol %, 19 mol %, 20 mol %, or within any range bound by any two of those values (e.g., from 9 mol % to 14 mol %, from 2 mol % to 18 mol %, and so on). In embodiments, the glass composition is substantially free of B₂O₃. For purposes of this disclosure, “substantially free” means that the component is not actively or intentionally added to the composition during initial batching but may be present as an impurity in an amount less than about 0.001 mol %.

In embodiments, the glass composition includes P₂O₅ in an amount within a range of from 0.1 mol % to 5.0 mol %. For example, the amount of P₂O₅ can be 0.1 mol %, 0.5 mol %, 1.0 mol %, 1.5 mol %, 2.0 mol %, 2.5 mol %, 3.0 mol %, 3.5 mol %, 4.0 mol %, 4.5 mol %, 5.0 mol %, or within any range bound by any two of those values (e.g., from 0.5 mol % to 4.0 mol %, from 1.0 mol % to 2.0 mol %, and so on). In embodiments, the glass composition is substantially free of P₂O₅.

In embodiments, the glass composition includes a total amount of R₂O (which is the total amount of alkali metal oxide(s) such as Li₂O, Na₂O, K₂O, Rb₂O, and Cs₂O) that is within a range of from 8 mol % to 20 mol %. For example, the amount of R₂O can be 8 mol %, 9 mol %, 10 mol %, 11 mol %, 12 mol %, 13 mol %, 14 mol %, 15 mol %, 16 mol %, 17 mol %, 18 mol %, 19 mol %, 20 mol %, or within any range bound by any two of those values (e.g., from 9 mol % to 14 mol %, from 9 mol % to 18 mol %, and so on). In embodiments, the glass composition is substantially free of one or more of Li₂O, K₂O, Rb₂O, and Cs₂O.

In embodiments, the glass composition includes Na₂O that is within a range of from 8 mol % to 20 mol %. For example, the amount of Na₂O can be 8 mol %, 9 mol %, 10 mol %, 11 mol %, 12 mol %, 13 mol %, 14 mol %, 15 mol %, 16 mol %, 17 mol %, 18 mol %, 19 mol %, 20 mol %, or within any range bound by any two of those values (e.g., from 9 mol % to 14 mol %, from 9 mol % to 18 mol %, and so on).

In embodiments, the glass composition includes K₂O that is within a range of from 0.1 mol % to 4.0 mol %. For example, the amount of K₂O can be 0.1 mol %, 0.5 mol %, 1.0 mol %, 1.5 mol %, 2.0 mol %, 2.5 mol %, 3.0 mol %, 3.5 mol %, 4.0 mol %, or within any range bound by any two of those values (e.g., from 0.1 mol % to 3.0 mol %, from 1.0 mol % to 2.0 mol %, and so on).

In embodiments, the glass composition includes a total amount of RO (which is the total amount of alkaline earth metal oxide(s) such as CaO, MgO, BaO, ZnO and SrO) that is within a range of from 0.1 mol % to 2.0 mol %. For example, the amount of RO can be 0.1 mol %, 0.2 mol %, 0.3 mol %, 0.4 mol %, 0.5 mol %, 0.6 mol %, 0.7 mol %, 0.8 mol %, 0.9 mol %, 1.0 mol %, 1.1 mol %, 1.2 mol %, 1.3 mol %, 1.4 mol %, 1.5 mol %, 1.6 mol %, 1.7 mol %, 1.8 mol %, 1.9 mol %, 2.0 mol %, or within any range bound by any two of those values (e.g., from 0.1 mol % to 1.5 mol %, from 1.0 mol % to 2.0 mol %, and so on).

In embodiments, the glass composition includes CaO that is within a range of from 0.1 mol % to 1.0 mol %. For example, the amount of CaO can be 0.1 mol %, 0.2 mol %, 0.3 mol %, 0.4 mol %, 0.5 mol %, 0.6 mol %, 0.7 mol %, 0.8 mol %, 0.9 mol %, 1.0 mol %, or within any range bound by any two of those values (e.g., from 0.1 mol % to 0.7 mol %, from 0.3 mol % to 0.5 mol %, and so on). In one or more embodiments, the glass composition is substantially free of CaO.

In embodiments, the glass composition includes MgO within a range of from 0.1 mol % to 7.0 mol %. For example, the amount of MgO can be 0.1 mol %, 0.5 mol %, 1.0 mol %, 1.5 mol %, 2.0 mol %, 2.5 mol %, 3.0 mol %, 3.5 mol %, 4.0 mol %, 4.5 mol %, 5.0 mol %, 5.5 mol %, 6.0 mol %, 6.5 mol %, 7.0 mol %, or within any range bound by any two of those values (e.g., from 0.1 mol % to 0.7 mol %, from 0.3 mol % to 0.5 mol %, and so on). In one or more embodiments, the glass composition is substantially free of MgO.

In embodiments, the glass composition includes an oxide that imparts a color or tint to the substrate 12 and, thus, to the article 10. In some embodiments, the glass composition includes an oxide that prevents discoloration of the substrate 12 when the substrate 12 is exposed to ultraviolet radiation. Examples of such oxides include, without limitation, oxides of: Ti, V, Cr, Mn, Fe, Co, Ni, Cu, Ce, W, and Mo.

In embodiments, the glass composition includes Fe expressed as Fe₂O₃, wherein Fe is present in an amount up to (and including) about 1 mol %. For example, the amount of Fe₂O₃ can be 0.1 mol %, 0.2 mol %, 0.3 mol %, 0.4 mol %, 0.5 mol %, 0.6 mol %, 0.7 mol %, 0.8 mol %, 0.9 mol %, 1.0 mol %, or within any range bound by any two of those values (e.g., from 0.1 mol % to 0.4 mol %, from 0.3 mol % to 0.5 mol %, and so on). In embodiments, the glass composition is substantially free of Fe.

In embodiments of the glass composition that includes TiO₂, TiO₂ may be present in an amount of about 5 mol % or less. For example, the amount of TiO₂ can be 0.1 mol %, 0.5 mol %, 1.0 mol %, 1.5 mol %, 2.0 mol %, 2.5 mol %, 3.0 mol %, 3.5 mol %, 4.0 mol %, 4.5 mol %, 5.0 mol %, or within any range bound by any two of those values (e.g., from 0.1 mol % to 0.5 mol %, from 0.5 mol % to 2.5 mol %, and so on). In one or more embodiments, the glass composition may be substantially free of TiO₂.

In more specific embodiments, the glass composition includes SiO₂ in an amount within a range of from 65 mol % to 75 mol %, Al₂O₃ in an amount within a range from 8 mol % to 14 mol %, Na₂O in an amount within a range of from 12 mol % to 17 mol %, K₂O in an amount within a range of from 0 mol % to 0.2 mol %, and MgO in an amount within a range of from 1.5 mol % to 6 mol %.

As mentioned, the article 10 further includes the first layer 14 of the high reflectance ink. The first layer 14 is layered over the second primary surface 20 of the substrate 12. The first layer 14 can directly contact the second primary surface 20 of the substrate 12, or, in some embodiments, an optional primer layer can be disposed between the substrate 12 and the first layer 14. “Directly contact” does not preclude the utilization of one or more adhesion promotors to promote adhesion of the first layer 14 to the second primary surface 20 of the substrate 12.

The first layer 14 of the high reflectance ink exhibits an ink index of refraction. The ink index of refraction is greater than the substrate index of refraction. In embodiments, the ink index of refraction is within a range of from 1.7 to 2.5. For example, the substrate index of refraction can be 1.7, 1.8, 1.9, 2.0, 2.1, 2.2, 2.3, 2.4, 2.5, or within any range bound by any two of those values (e.g., from 1.9 to 2.2, from, 2.0 to 2.4, and so on).

The first layer 14 of the high reflectance ink has a thickness 24. The thickness 24 is measured orthogonal to the second primary surface 20 of the substrate 12. The thickness 24 can be measured with a micrometer or scanning electron microscope. In embodiments, the thickness 24 is within a range of from 2.0 μm to 10.0 μm. For example, the thickness 24 can be 2.0 μm, 2.5 μm, 3.0 μm, 3.5 μm, 4.0 μm, 4.5 μm, 5.0 μm, 5.5 μm, 6.0 μm, 6.5 μm, 7.0 μm, 7.5 μm, 8.0 μm, 8.5 μm, 9.0 μm, 9.5 μm, 10.0 μm, or within any range bound by any two of those values (e.g., from 2.5 μm to 8.0 μm, from 3.5 μm to 6.0 μm, and so on).

The high reflectance ink has a composition, and the composition is substantially free of a metallic component. “Metallic component” for purposes of this disclosure means a metal in its elemental form and does not preclude the inclusion of a metal oxide. In embodiments, the composition includes a polymer resin. Example polymer resins include acrylic, polyester, and epoxy resins. In embodiments, the composition includes high refractive index particles, such as TiO₂ or ZrO₂. In embodiments, the composition includes a colorant. The colorant can be a non-metallic colorant. In embodiments, the composition can further include a solvent (e.g., an alcohol, a ketone, or an ether) to dilute or suspect the colorant and/or the resin. The composition can further include one or more additives, such as a hardener.

In embodiments, the first layer 14, when considered alone, exhibits a transmittance of electromagnetic radiation throughout an entirety of the visible spectrum that is greater than or equal to 50%. For example, the transmittance of the first layer 14 can be 50%, 55%, 60%, 65%, 70%, 75%, 80%, 85%, or greater than 85%, or within any range bound by any two of those values (e.g., from 55% to 65%, from 60% to 70%, and so on). Similarly, the first layer 14 and the substrate 12 together exhibit a transmittance of electromagnetic radiation throughout an entirety of the visible spectrum that is greater than or equal to 50%. For example, the transmittance of electromagnetic radiation throughout an entirety of the visible spectrum that the first layer 14 and the substrate 12 together exhibit can be 50%, 55%, 60%, 65%, 70%, 75%, 80%, 85%, 90%, or greater than 90%, or within any range bound by any two of those values (e.g., from 55% to 70%, from 60% to 75%, and so on).

In embodiments, when disposed on the substrate 12, the first layer 14 exhibits a reflectance of greater than or equal to 1% throughout an entirety of the visible spectrum for electromagnetic radiation that is initially transmitted though the substrate 12 and incident on the first layer 14. The reflectance of the first layer 14 can vary considerably as a function of wavelength throughout the visible spectrum. In embodiments, the reflectance of the first layer 14 (for electromagnetic radiation initially incident on the first layer 14 through the substrate 12), as a function of wavelength within the visible spectrum, can vary within a range of from 1% to 12%. In embodiments, the reflectance that the first layer 14 exhibits (for electromagnetic radiation initially incident on the first layer 14 through the substrate 12) at one or more wavelengths or wavelength ranges within the visible spectrum is 1%, 2%, 3%, 4%, 5%, 6%, 7%, 8%, 9%, 10%, 11%, 12%, or within any range bound by any two of those values (e.g., from 5% to 10%, from 6% to 9%, and so on). Unless otherwise noted, reflectance values provided herein are for an angle of incidence of 8 degrees from normal to the second primary surface 20 of the substrate 12.

As mentioned, the article 10 further includes the second layer 16 of the substantially opaque ink. The second layer 16 is layered over the first layer 14. The first layer 14 is thus sandwiched between the second layer 16 and the substrate 12. In embodiments, the second layer 16 is disposed directly on the first layer 14 without any other interlayer therebetween. In embodiments, the second layer 16 exhibits an optical density of at least 1.0, at least 2.0, at least 3.0, or even at least 4.0 for light in the visible spectrum. For example, in embodiments, the second layer 16 exhibits an optical density greater than or equal to 1.0 and less than or equal to 6.0, greater than or equal to 1.5 and less than or equal 6.0, greater than or equal to 2.0 and less than or equal to 6.0, greater than or equal to 3.0 and less than or equal 6.0, or greater than or equal to 4.0 and less than or equal to 6.0. In embodiments, the second layer 16 exhibits an optical density of 1.0, 1.5, 2.0, 2.5, 3.0, 3.5, 4.0, 4.5, 5.0, 5.5, 6.0, or within any range bound by any two of those values (e.g., from 2.0 to 6.0, from 1.5 to 3.5, and so on). Optical density is a measure of absorbance of the material tested, as measured with a spectrophotometer given by Optical Density=−log(I/I₀) where I₀ is the intensity of light incident on the sample and/is the intensity of light that is transmitted through the sample. For instance, an optical density of 3.0 means that 99.9% of the light is absorbed by the material. The greater the optical density, the greater the percentage of light absorbed by the material. A value for optical density herein is the average of optical density values measured over the visible spectrum.

In embodiments, the article 10 exhibits an average reflectance throughout an entirety of the visible spectrum of electromagnetic radiation initially transmitted through the substrate 12 that is greater than an average reflectance that a comparative article with only the substrate 12 and the second layer 16 (and not the first layer 14) exhibits. In short, the inclusion of the high reflectance ink enhances the reflectance of electromagnetic radiation initially transmitted through the substrate 12. In some instances, the average reflectance that the article 10 exhibits is at least 0.1% greater than the average reflectance that comparative article exhibits. For example, the average reflectance that the article 10 exhibits can be greater than the average reflectance that the comparative article 14 exhibits by greater than 0%, 0.1%, 0.2%, 0.3%, 0.4%, 0.5%, 0.6%, 0.7%, 0.8%, 0.9%, 1%, 2%, 3%, 4%, 5%, greater than 5%, or within any range bound by any two of those values (e.g., from greater than 0% to 0.4%, from 1% to 3%, and so on).

In embodiments, for electromagnetic radiation throughout an entirety of the visible spectrum initially transmitted through the first primary surface 18 of the substrate 12 and incident on the first layer 14, the article 10 exhibits an average reflectance that is greater than or equal to 4%. In embodiments, the average reflectance that the article 10 exhibits is 4%, 5%, 7.5%, 10%, 12.5%, 15%, 17.5%, 20%, 22.5%, 25%, 27.5%, 30%, 32.5%, 35%, 37.5%, 40%, or within any range bound by any two of those values (e.g., from 10% to 17.5%, from 20% to 32.5%, and so on).

The article 10 exhibits L*, a*, and b* values under the Commission Internationale de l'Eclairage (CIE) system. Unless noted otherwise, the L*, a*, and b* values are with the specular component included (SCI). In embodiments, the L* value that the article 10 exhibits is greater than the L* value that a comparative article with only the substrate 12 and the second layer 16 disposed directly on the substrate 12 (e.g., without the first layer 14) exhibits. In short, in those embodiments, the article 10 exhibits a greater degree of whiteness than the comparative article because of the inclusion of the first layer 14 of the high reflectance ink. The values for L*, a*, and b* can be determined from specular reflectance measurements using a spectrophotometer.

In embodiments, the article 10 exhibits an L* value that is greater than or equal to 24 when measured from a viewpoint toward the first primary surface 18. The L* value exhibited may depend on a color exhibited by the second layer 16 alone. For example, when the substantially opaque ink of the second layer 16 has a black color, the article 10 may exhibit an L* value that is greater than or equal to 24 and less than or equal to 30. When the substantially opaque ink of the second layer 16 exhibits a color other than black, the L* value may be higher than when substantially opaque ink of the second layer 16 has a black ink. In such embodiments, the article 10 may exhibit an L* value that is greater than or equal to 28, greater than or equal to 30, greater than or equal to 35, greater than or equal to 40, greater than or equal to 45, greater than or equal to 50, greater than or equal to 60, or even greater than or equal to 70. More particularly, when the substantially opaque ink of the second layer 16 has a gray color, the article 10 may exhibit an L* of 50, 52, 54, 56, 58, 60, 62, 64, 66, 68, 70, or within any range bound by any two of those values (e.g., from 50 to 70, from 52 to 66, and so on). Exhibiting such L* values, in combination with the reflectance in the visible spectrum described herein, beneficially provides the article 10 with a shiny, metallic appearance.

In embodiments, the article 10 compared to a comparative article with only the substrate 12 and the second layer 16 disposed on the substrate 12 (e.g., without the first layer 14 of the high reflectance ink) exhibits a ΔE that is less than 1.0. In short, despite the effect that the first layer 14 of the high reflectance ink has on increasing reflectance of visible light back through the substrate 12 and on increasing the whiteness that the article 10 exhibits, the first layer 14 of the high reflectance ink, in those embodiments, does not cause a perceptible color change compared to the comparative article. For example, the ΔE can be 0.1, 0.2, 0.3, 0.4, 0.5, 0.6, 0.7, 0.8, 0.9, 1.0, or within any range bound by any two of those values (e.g., from 0.1 to 0.9, from 0.3 to 0.4, and so on). In other embodiments, the ΔE is greater than 1.0. For purposes of this disclosure, ΔE is calculated according to the following equation:

$$Δ E = \sqrt{{( Δ {L}^{*} )}^{2} + {( Δ {a}^{*} )}^{2} + {( Δ {b}^{*} )}^{2}}$$

In embodiments, the article 10 further includes a functional layer 26. The functional layer 26 is layered over the first primary surface 18 of the substrate 12. Exemplary functional layers 26 include at least one of a glare reduction coating, a scratch resistance coating, an anti-reflection coating, and an easy-to-clean coating.

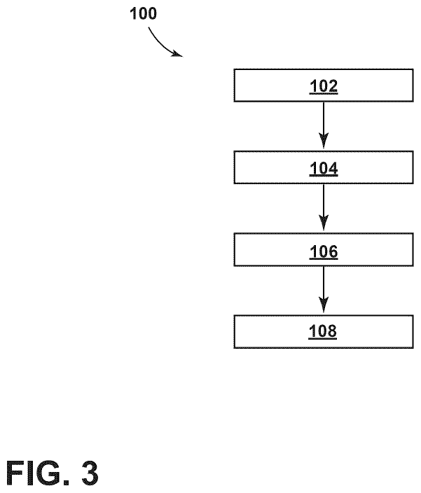

Referring now to FIG. 3, a method 100 of making the article 10 is further disclosed herein. The method 100 includes a first printing step 102, a first curing step 104, a second printing step 106, and a second curing step 108. The method 100 can be performed in that order.

The first printing step 102 includes printing the first layer 14 of the high reflectance ink onto the second primary surface 20 of the substrate 12. Printing for the first printing step 102 can include inkjet printing, screen printing, pad printing, or spin printing the first layer 14 of the high reflectance ink onto the second primary surface 20 of the substrate 12. In embodiments, the inkjet printer can have a printhead with 128 to 2560 nozzles, with each nozzle ejecting from 3 pL to 40 pL of the high reflectance ink.

The first curing step 104 includes curing the first layer 14. In embodiments, the curing of the first curing step 104 includes curing the first layer 14 with ultraviolet light, thermal treatment, and infrared light. In embodiments, after the first curing step 104 but before the second printing step 106, the article 10 exhibits a CIE colorimetry system L* value, with the specular component included, that is within a range of from 35 to 45. For example, the L* can be 35, 36, 37, 38, 39, 40, 41, 42, 43, 44, 45, or within any range bound by any two of those values (e.g., from 38 to 41, from 40 to 44, and so on). In embodiments, after the first curing step 104 but before the second printing step 106, the article 10 exhibits a CIE colorimetry system a* value, with the specular component included, that is within a range of from −1.0 to 1.0. For example, the a* can be −1.0, −0.9, −0.8, −0.7, −0.6, −0.5, −0.4, −0.3, −0.2, −0.1, 0, 0.1, 0.2, 0.3, 0.4, 0.5, 0.6, 0.7, 0.8, 0.9, 1.0, or within any range bound by any two of those values (e.g., from 0 to 0.8, from −0.8 to 0.1, and so on). In embodiments, after the first curing step 104 but before the second printing step 106, the article 10 exhibits a CIE colorimetry system b* value, with the specular component included, that is within a range of from −1.0 to 1.0. For example, the b* can be −1.0, −0.9, −0.8, −0.7, −0.6, −0.5, −0.4, −0.3, −0.2, −0.1, 0, 0.1, 0.2, 0.3, 0.4, 0.5, 0.6, 0.7, 0.8, 0.9, 1.0, or within any range bound by any two of those values (e.g., from 0 to 0.8, from −0.8 to 0.1, and so on).

The second printing step 106 includes printing the second layer 16 onto the first layer 14. Printing for the second printing step 106 can include inkjet printing, screen printing, pad printing, or spin printing the second layer 16 of the opaque ink onto the second primary surface 20 of the substrate 12. The first printing step 102 and the second printing step 106 can utilize the same mode of printing (e.g., both can use inkjet printing).

The second curing step 108 includes curing the second layer 16. In embodiments, the curing of the second curing step 108 includes curing the second layer 16 with ultraviolet light, thermal treatment, and infrared light. In embodiments, the method 100 is free of an etching step that removes a portion of the first layer 14 or the second layer 16.

In embodiments, after the second printing step 106, when the substantially opaque ink has a black color, the article 10 exhibits a CIE colorimetry system a* value, with the specular component included, that is within a range of from −2.0 to 2.0, and a b* value, with the specular component included, that is likewise within a range of from −2.0 to 2.0 For example, the a* can be −2.0, −1.9, −1.8, −1.7, −1.6, −1.5, −1.4, −1.3, −1.2, −1.1, −1.0, −0.9, −0.8, −0.7, −0.6, −0.5, −0.4, −0.3, −0.2, −0.1, 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0 or within any range bound by any two of those values (e.g., from 0 to 0.8, from −0.8 to 0.1, and so on). For example, the b* can be −2.0, −1.9, −1.8, −1.7, −1.6, −1.5, −1.4, −1.3, −1.2, −1.1, −1.0, −0.9, −0.8, −0.7, −0.6, −0.5, −0.4, −0.3, −0.2, −0.1, 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, or within any range bound by any two of those values (e.g., from 0 to 0.8, from −0.8 to 0.1, and so on).

In embodiments, after the second printing step 106, when the substantially opaque ink has a red color, the article 10 exhibits a CIE colorimetry system a* value, with the specular component included, that is within a range of from 3.0 to 14.0, and a b* value, with the specular component included, that is likewise within a range of from 1.0 to 7.0. For example, the a* can be 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, or within any range bound by any two of those values (e.g., from 8.5 to 11.0, from 9.0 to 13.5, and so on). For example, the b* can be 0.5, 1.0, 1.5, 2.0, 2.5, 3.0, 3.5, 4.0, 4.5, 5.0, 5.5, 6.0, 6.5, 7.0, or within any range bound by any two of those values (e.g., from 1.5 to 3.0, from 3.5 to 5.0, and so on).

In embodiments, after the second printing step 106, when the substantially opaque ink has a gold color, the article 10 exhibits a CIE colorimetry system a* value, with the specular component included, that is within a range of from 1.0 to 6.0, and a b* value, with the specular component included, that is likewise within a range of from 22.0 to 32.0. For example, the a* can be 1.0, 1.5, 2.0, 2.5, 3.0, 3.5, 4.0, 4.5, 5.0, 5.5, 6.0, 6.5, 7.0, or within any range bound by any two of those values (e.g., from 1.5 to 3.5, from 3.0 to 6.5, and so on). For example, the b* can be 22.0, 22.5, 23.0, 23.5, 24.0, 24.5, 25.0, 25.5, 26.0, 26.5, 27.0, 28.5, 29.0, 29.5, 30.0, 30.5, 31.0, 31.5, 32.0, or within any range bound by any two of those values (e.g., from 22.5 to 27.0, from 26.0 to 31.5, and so on).

The article 10 and the method 100 of the present disclosure address the issues presented in the Background, in a variety of ways. Among them, the inclusion of the first layer 14 of the high reflectance ink enhances reflectance of the second layer 16 of the substantially opaque ink back through the substrate 12. The enhanced reflectance causes a perception that the article 10 is metallic. Yet no metal is included in the substrate 12, the first layer 14 of the high reflectance ink, or the second layer 16 of the substantially opaque ink. Thus, the article 10 and the method 100 avoid the suboptimal cost of metal as a raw material and the deposition processes utilized to apply metal. The article 10 provides the visual perception of metal without the inclusion of any. A color of the substantially opaque ink can be chosen so that the article 10 exhibits the desired metallic appearance (e.g., gold, silver, and so on). The higher the index of refraction of the first layer 14 of the high reflectance ink, the more vivid in color and metallic the article 10 will appear. The same high reflectance ink can be utilized with any number of opaque inks of different colors and still provide the same reflectance enhancing and metallic appearance effects.

The article 10 can be utilized within an interior of a vehicle, such as to provide a surface visible to an occupant of the vehicle at a dashboard or center console.

### EXAMPLES

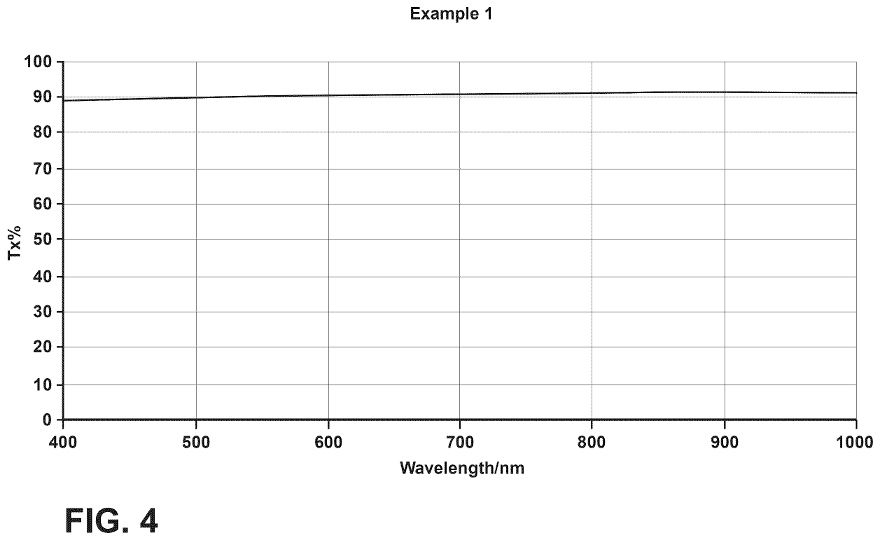

Example 1—For Example 1, a layer of a high reflectance ink was printed onto a primary surface of a glass substrate to form a workpiece. The high reflectance ink had a composition that included acrylic resin and was obtained from Seiko Advance (China) as product code HF SG4127. The glass substrate had an alkali-aluminosilicate glass composition. The transmission percentage of the workpiece as a function of wavelength was determined. The results were plotted on the graph reproduced at FIG. 4. The graph reveals that the workpiece of the substrate and the layer of the high reflectance ink exhibited a transmittance of about 90% for the entirety of the visible spectrum.

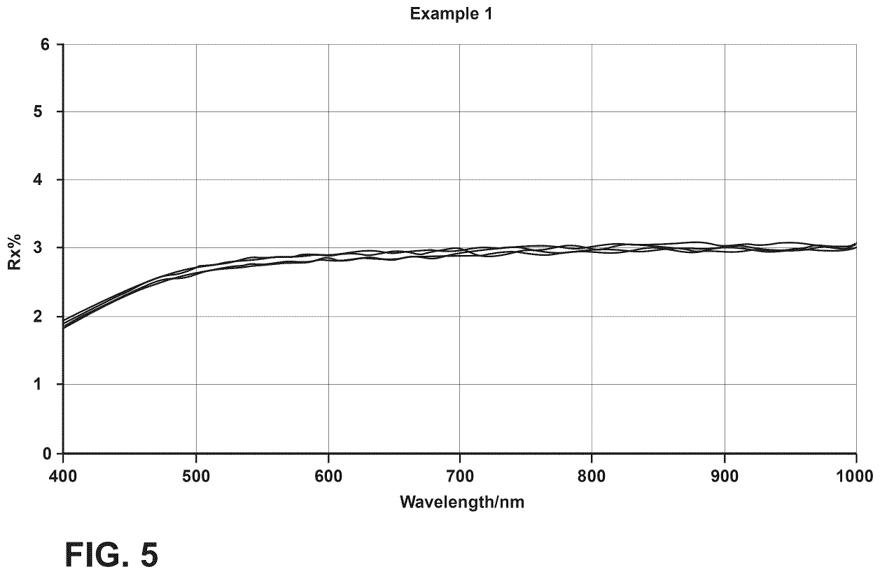

In addition, the reflectance percentage of the workpiece as a function of wavelength was determined four separate times using a CM700D spectrophotometer (Konica Minolta). The results were plotted on the graph reproduced at FIG. 5. The graph reveals that the layer of the high reflectance ink exhibited a reflectance within a range of about 2% to about 3% for the entirety of the visible spectrum.

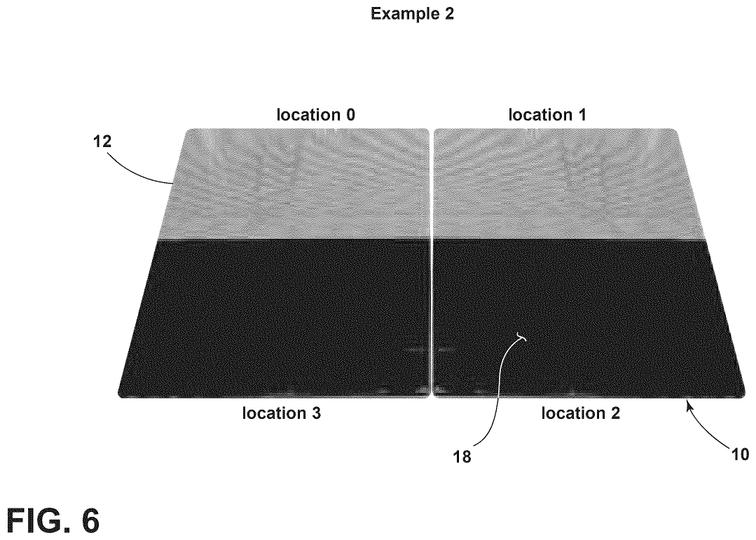

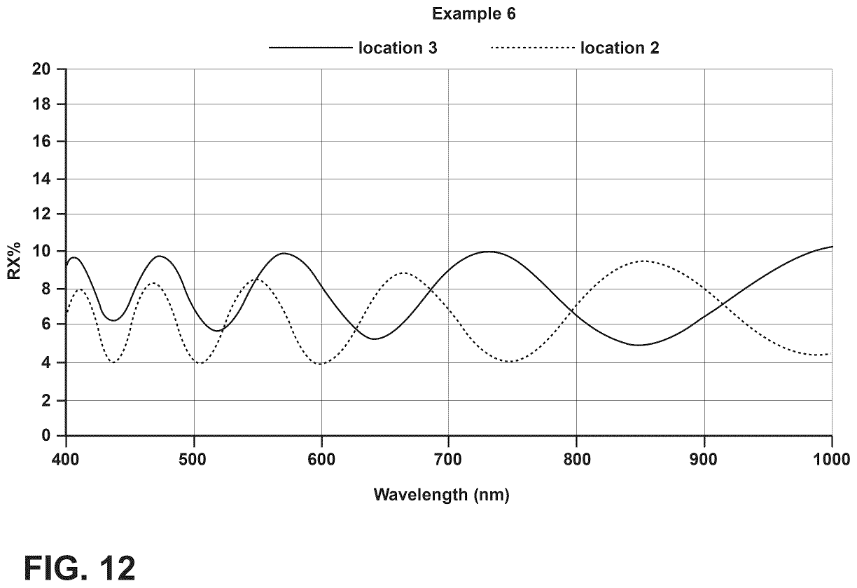

Examples 2-5—For each of Examples 2-5, two glass coupons were prepared. An image of Example 2 is reproduced at FIG. 6. An image of Example 6 is reproduced at FIG. 12. For each of the examples, one location on one of the glass coupons (“location 0”) was kept as bare glass, while at another location on the glass coupon (“location 3”), a layer of the opaque ink was added over the primary surface of the glass coupon without a layer of the high reflectance ink therebetween. With the other of the two glass coupons, at one location (“location 1”), a layer of a high reflectance ink was added to a primary surface of the glass coupon, while at another location (“location 2”), a layer of the high reflectance ink was added to a primary surface of the glass coupon and a layer of opaque ink was added over the layer of the high reflectance ink. Examples 2-4 each included a different black matrix ink as the opaque ink. Example 5 included a golden colored ink as the opaque ink.

The CEI L*, a*, b* values were determined for each of the three ink layered glass coupons of Examples 2-5, again using the CMD700D spectrophotometer. The results are reproduced in Table 1 below. In the table, “SCI” means specular component included, “SCE” means specular component excluded, and “y” is the average reflectance throughout the visible spectrum. The results reveal that the addition of the layer of the high reflectance ink to the opaque ink (location 2) increases the L*, a*, and b* values relative to just the opaque ink on the glass coupon (location 3), for all of Examples 2-5. The AEs for the Examples, comparing the color change due to the inclusion of the high reflectance ink (location 2 versus location 3), are low. For instance, the ΔE for Example 3 is 0.34.

TABLE 1

| Exam- | loca- | SCI | | | | SCE | | | |
|---|---|---|---|---|---|---|---|---|---|
| ple | tion | L* | a* | b* | γ | L* | a* | b* | γ |
| Ex. 2 | 1 | 33.82 | −0.09 | −0.67 | 7.92 | 0.42 | −0.13 | −0.10 | 0.05 |
| | 2 | 25.21 | −0.02 | −0.32 | 4.48 | 0.41 | −0.1 | −0.08 | 0.05 |
| | 3 | 25.08 | −0.04 | −0.39 | 4.44 | 0.34 | −0.14 | −0.08 | 0.04 |
| Ex. 3 | 1 | 33.82 | −0.09 | −0.67 | 7.92 | 0.42 | −0.13 | −0.10 | 0.05 |
| | 2 | 29.87 | 0.19 | 0.19 | 6.18 | 1.50 | −0.12 | −1.44 | 0.17 |
| | 3 | 29.56 | 0.12 | 0.08 | 6.06 | 0.40 | −0.12 | −0.08 | 0.04 |
| Ex. 4 | 1 | 33.82 | −0.09 | −0.67 | 7.92 | 0.42 | −0.13 | −0.10 | 0.05 |
| | 2 | 26.17 | −0.04 | −0.17 | 4.80 | 5.17 | −0.27 | 0.07 | 0.57 |
| | 3 | 25.96 | −0.07 | −0.36 | 4.74 | 5.01 | −0.30 | 0.21 | 0.55 |
| Ex. 5 | 1 | 33.82 | −0.09 | −0.67 | 7.92 | 0.42 | −0.13 | −0.10 | 0.05 |
| | 2 | 72.60 | 3.73 | 29.54 | 44.57 | 63.70 | 3.88 | 32.09 | 32.44 |
| | 3 | 72.22 | 3.42 | 28.43 | 43.98 | 63.89 | 3.68 | 31.44 | 32.66 |

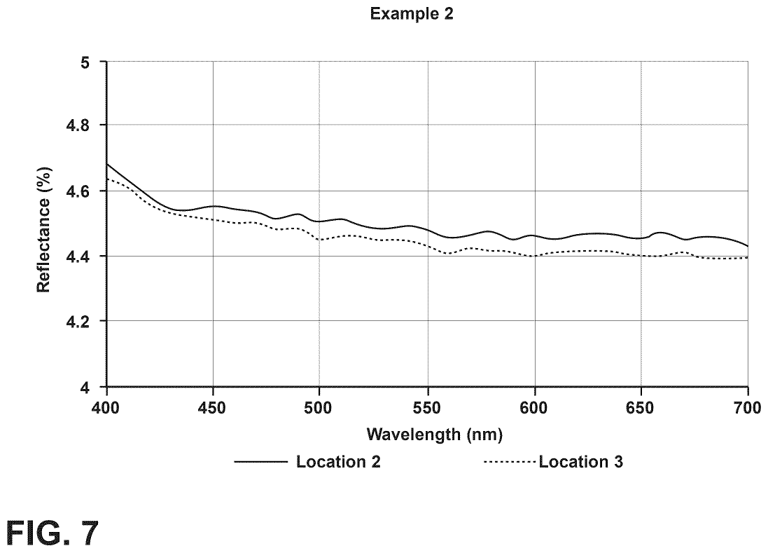

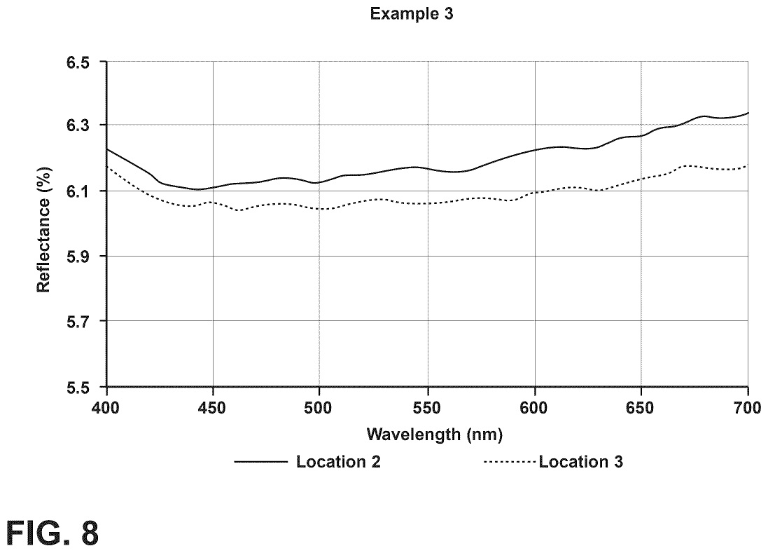

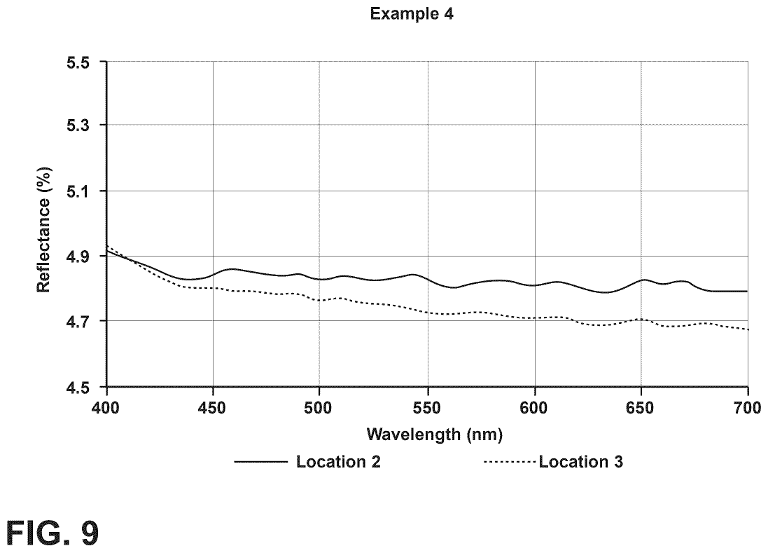

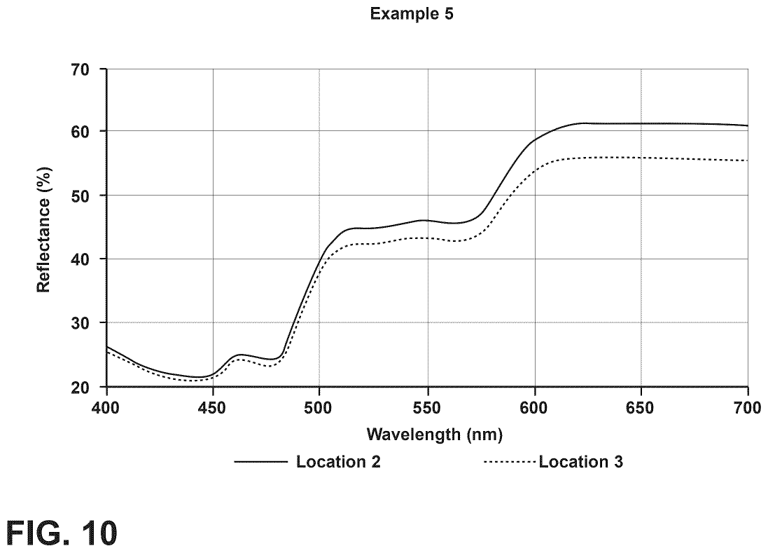

In addition, the reflectance (as a function of wavelength) of visible light initially incident through the glass coupon back through the glass coupon due to the presence of both the layer of the high reflectance ink and the layer of the opaque ink (location 2) and the presence of just the layer of the opaque ink (location 3) was determined for each example. The results are reproduced at FIGS. 7-10. The graphs reveal that the inclusion of the layer of the high reflectance ink increases reflectance back through the glass coupon throughout the entirety of the visible spectrum.

Example 6—For Example 6, a different high reflectance ink than for Examples 2-5 was utilized and tested. The high reflectance ink was PixJet® (Pixelligent, Maryland USA) and had a composition that includes an acrylic based polymer and TiO₂ as high refractive index particles. In a first test, the high reflectance ink was applied to a primary surface of a glass substrate. As a comparison, a non-high reflectance ink was applied to a primary surface of another glass substrate having the same composition. The reflectance as a function of wavelength was then determined for visible light initially incident through the glass substrate. The results are provided in the graph reproduced at FIG. 12. As the graph reveals, this high reflectance ink enhances reflectance back through the glass substrate compared to the comparison ink for most wavelength ranges within the visible spectrum. The oscillations in reflectance are thought to be a consequence of the ink layer having a thickness sufficiently related to the visible spectrum wavelengths to generate an interference effect.

Examples 7-11—For these examples, five substantially opaque inks were analyzed with and without the high reflectance ink disposed between the substantially opaque ink and the glass substrate, to determine how the high reflectance ink would affect reflectance back through the substrate and color. The “location 0” through “location 3” scheme utilized for Examples 2-6 was also utilized for Examples 7-11. For instance, referring to Example 7, location 0 would have been the bare glass, location 1 is the workpiece with the first layer of the high reflectance ink on a primary surface of the glass substrate, location 2 is the article of the present disclosure with the first layer of the high reflectance ink on the primary surface of the glass substrate and a second layer of substantially opaque ink (106-070 black matrix) over the first layer, and location 3 is a workpiece with a layer of the substantially opaque ink over the primary surface of the glass substrate without the first layer of the high reflectance ink. The substantially opaque ink for Example 7 was code 106-070 from Seiko Advance (China). Examples 8-11 used the same scheme but with a different substantially opaque ink for each. The substantially opaque inks were Pantone® 186C red ink from Seiko Advance for Example 8, Pantone® 348C green ink from Seiko Advance for Example 9, a wood pattern printed via ink jet for Example 10, and another wood pattern printed via ink jet for Example 11.

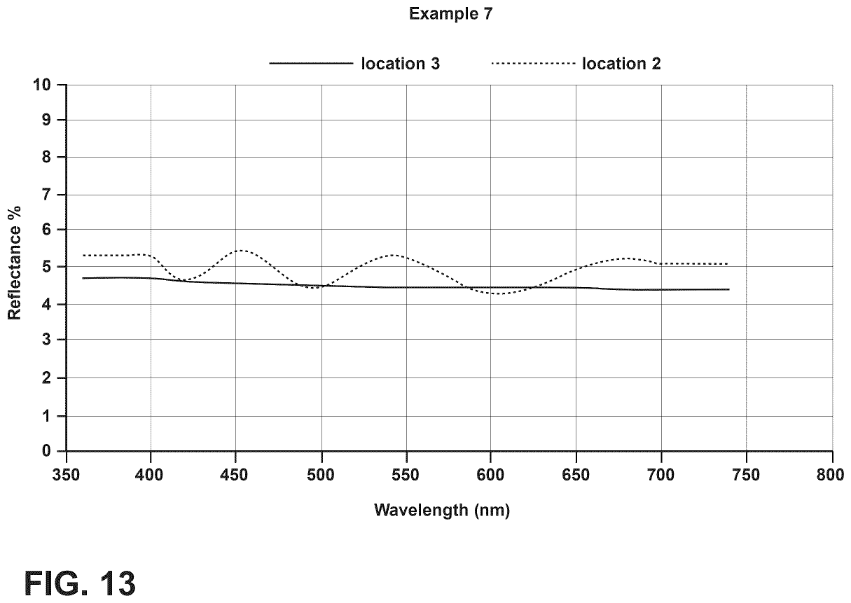

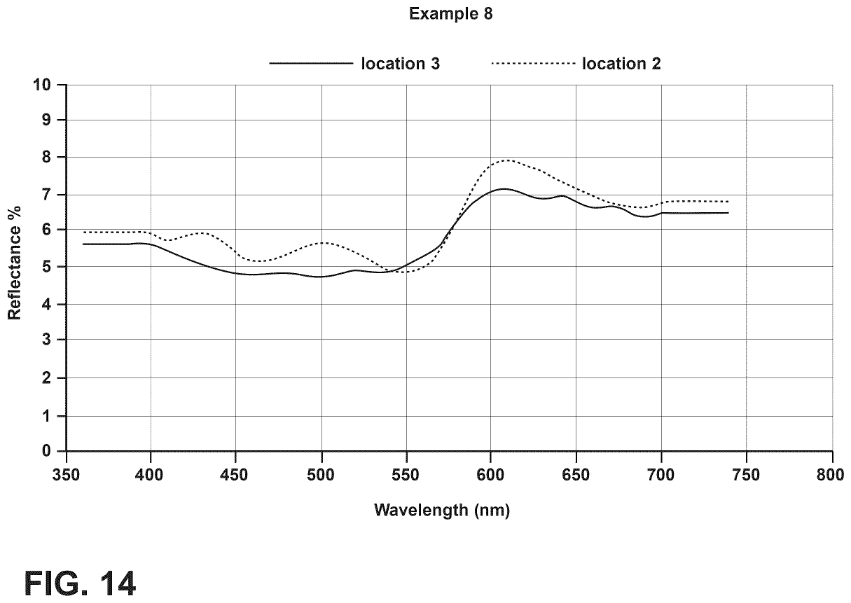

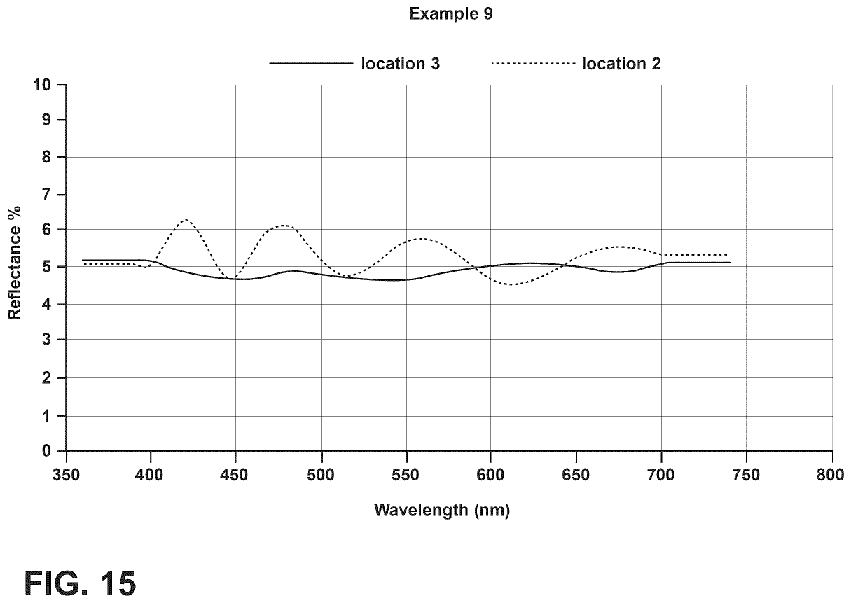

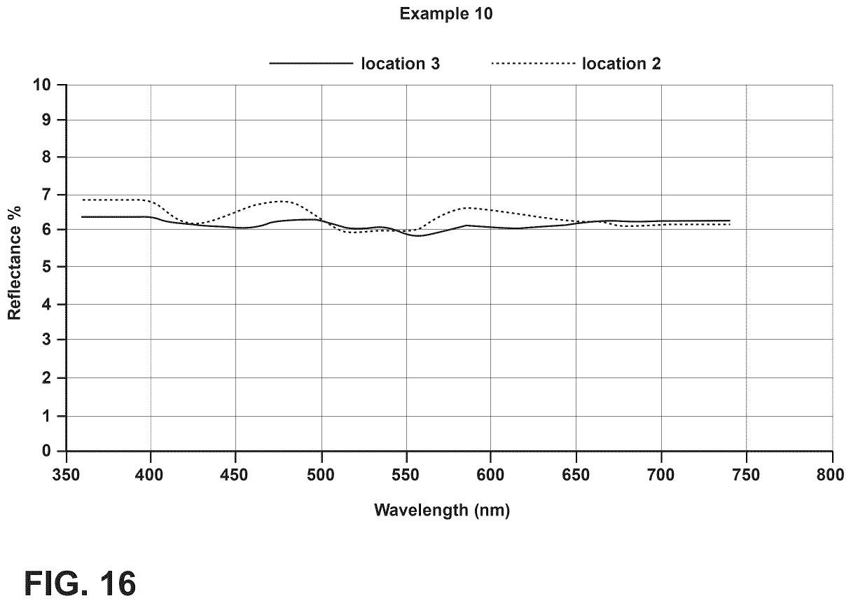

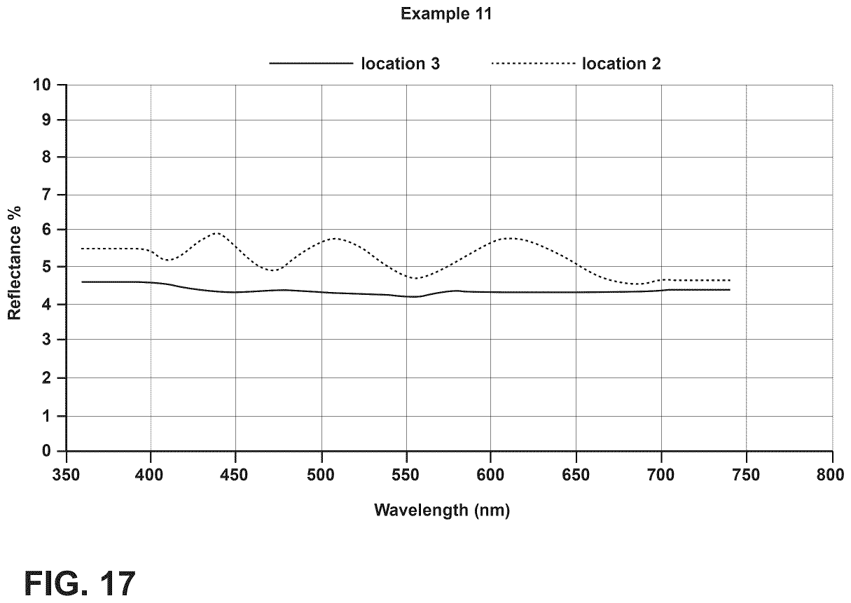

The reflectance spectra for “location 2” with the high reflectance ink and “location 3” without the high reflectance ink for Examples 7-11 are revealed in the graphs reproduced in FIGS. 12-17, respectively. As the graphs reveal, the inclusion of the high reflectance ink enhances reflectance of electromagnetic radiation initially incident through the glass substrate back through the glass substrate for all or most wavelength ranges within the visible spectrum, depending on the particular example.

The CIE color data for each of Examples 7-11 is reproduced in Table 2 below. As the data in the table reveals, the inclusion of the high reflectance ink (location 2) increases the L* (whiteness) and γ (reflectance) that the article exhibits.

TABLE 2

| Exam- | loca- | SCI | | | | SCE | | | |
|---|---|---|---|---|---|---|---|---|---|
| ple | tion | L* | a* | b* | γ | L* | a* | b* | γ |
| Ex. 8 | 1 | 41.6 | 4.13 | −1.92 | 12.24 | 4.51 | −0.42 | −2.13 | 0.5 |
| | 2 | 26.45 | −1.04 | −1.14 | 4.9 | 0.84 | −0.1 | −0.37 | 0.09 |
| | 3 | 25.36 | −0.04 | −0.41 | 4.53 | 0.38 | −0.04 | −0.22 | 0.04 |
| Ex. 9 | 1 | 41.6 | 4.13 | −1.92 | 12.24 | 4.51 | −0.42 | −2.13 | 0.5 |
| | 2 | 29.06 | 6.24 | 1.54 | 5.86 | 9.41 | 14.31 | 5.88 | 1.05 |
| | 3 | 28.27 | 5.57 | 3.02 | 5.56 | 8.47 | 14.75 | 5.53 | 0.94 |
| Ex. 10 | 1 | 41.6 | 4.13 | −1.92 | 12.24 | 4.51 | −0.42 | −2.13 | 0.5 |
| | 2 | 27.62 | −1.23 | −0.91 | 5.32 | 3.88 | −1.21 | −0.67 | 0.43 |
| | 3 | 26.38 | 1.01 | 0.26 | 4.88 | 3.64 | −0.44 | −0.89 | 0.4 |
| Ex. 11 | 1 | 41.6 | 4.13 | −1.92 | 12.24 | 4.51 | −0.42 | −2.13 | 0.5 |
| | 2 | 30.18 | 1.27 | −0.93 | 6.31 | 3.41 | 0.92 | −0.94 | 0.38 |
| | 3 | 29.72 | 0.09 | −0.35 | 6.12 | 2.89 | 0.84 | −0.66 | 0.32 |
| Ex. 12 | 1 | 41.6 | 4.13 | −1.92 | 12.24 | 4.51 | −0.42 | −2.13 | 0.5 |
| | 2 | 27.41 | 0.88 | −0.85 | 5.28 | 3.19 | 0.29 | −0.97 | 0.35 |
| | 3 | 24.59 | 0.3 | −0.39 | 4.28 | 3.59 | 0.94 | −1.44 | 0.4 |

What is claimed is:

1. An article comprising:
a substrate (i) comprising a first primary surface and a second primary surface facing generally away from the first primary surface and (ii) exhibiting a substrate index of refraction;
a first layer of a high reflectance ink (i) layered over the second primary surface of the substrate and (ii) exhibiting an ink index of refraction that is greater than the substrate index of refraction; and
a second layer of a substantially opaque ink, the second layer layered over the first layer, with the first layer sandwiched between the second layer and the substrate;
wherein, the first layer is substantially free of a metallic component, and
wherein, for electromagnetic radiation throughout an entirety of the visible spectrum initially transmitted through the first primary surface of the substrate and incident on the first layer, the article exhibits an average reflectance that is greater than or equal to 4%.

2. The article of claim 1, wherein
the substrate further comprises a thickness between the first primary surface and the second primary surface, and
the thickness of the substrate is within a range of from 0.1 mm to 5.0 mm.

3. The article of claim 1, wherein
the substrate alone exhibits a transmittance of electromagnetic radiation throughout an entirety of the visible spectrum that is greater than or equal to 80%.

4. The article of claim 1, wherein
the first layer comprises a thickness orthogonal to the second primary surface of the substrate, and
the thickness of the first layer is within a range of from 2.0 μm to 10.0 μm.

5. The article of claim 1, wherein the high reflectance ink of the first layer comprises at least one of a resin and a non-metallic colorant.

6. The article of claim 1, wherein the first layer directly contacts the second primary surface of the substrate.

7. The article of claim 1, wherein the first layer exhibits a reflectance of greater than or equal to 1% throughout an entirety of the visible spectrum for electromagnetic radiation that is initially transmitted through the substrate and incident on the first layer.

8. The article of claim 1, wherein
the second layer is disposed directly on the first layer without any other interlayer therebetween.

9. The article of claim 1, wherein
the article exhibits an average reflectance throughout an entirety of the visible spectrum of electromagnetic radiation initially transmitted through the substrate that is greater than an average reflectance that a comparative article with only the substrate and the second layer disposed directly on the substrate exhibits.

10. The article of claim 9, wherein
the average reflectance that article exhibits is at least 0.1% greater than the average reflectance that the comparative article exhibits.

11. The article of claim 1, wherein
the article exhibits an L* value, with the specular component included (SCI) under the CIE colorimetric system, that is greater than the L* value that a comparative article with only the substrate and the second layer disposed directly on the substrate exhibits.

12. The article of claim 11, wherein
the article compared to the comparative article, exhibits a ΔE, with the specular component included (SCI) under the CIE colorimetric system, that is less than 1.0.

13. An article comprising:
a substrate (i) comprising a first primary surface and a second primary surface facing generally away from the first primary surface and (ii) exhibiting a substrate index of refraction;
a first layer of a high reflectance ink (i) layered over the second primary surface of the substrate and (ii) exhibiting an ink index of refraction that is greater than the substrate index of refraction; and
a second layer of a substantially opaque ink, the second layer layered over the first layer, with the first layer sandwiched between the second layer and the substrate;
wherein, for electromagnetic radiation throughout an entirety of the visible spectrum initially transmitted through the first primary surface of the substrate and incident on the first layer, the article exhibits an average reflectance that is greater than or equal to 4%, and
wherein, the article exhibits an L* value, with the specular component included (SCI) under the CIE colorimetric system, that is greater than or equal to 24 when measured from a viewpoint toward the first primary surface.

14. The article of claim 13, wherein
the first layer is substantially free of a metallic component.

15. The article of claim 13, wherein
the article exhibits a CIE colorimetry system a* value, with the specular component included, that is within a range of from −2.0 to 2.0, and a b* value, with the specular component included, that is likewise within a range of from −2.0 to 2.0.

16. The article of claim 13, wherein
the article exhibits a CIE colorimetry system a* value, with the specular component included, that is within a range of from 3.0 to 14.0, and a b* value, with the specular component included, that is likewise within a range of from 1.0 to 7.0.

17. The article of claim 13, wherein
the article exhibits a CIE colorimetry system a* value, with the specular component included, that is within a range of from 1.0 to 6.0, and a b* value, with the specular component included, that is likewise within a range of from 22.0 to 32.0.

18. A method of making the article of claim 13, comprising:
a first printing step comprising printing the first layer of the high reflectance ink onto the second primary surface of the substrate;
a first curing step comprising curing the first layer, the first curing step performed after the first printing step;
a second printing step comprising printing the second layer onto the first layer, the second printing step performed after the first curing step; and
a second curing step comprising curing the second layer, the second curing step performed after the second printing step.

19. The method of claim 18, wherein
the printing of the first printing step comprises inkjet printing, screen printing, pad printing, or spin printing the first layer of the high reflectance ink onto the second primary surface of the substrate.

20. The method of claim 18, wherein
the first curing step comprises curing the first layer with one or more of ultraviolet light, thermal treatment, and infrared light.
